(19) United States
(12) Patent Application Publication
(10) Pub. No.: US 2026/0208327 A1
(43) Pub. Date: Jul. 23, 2026

(54) THREE JAW ADJUSTABLE SOCKET RATCHET WRENCH ASSEMBLY

(71) Applicant: Thomas Carnesi, Torrance, CA (US)

(72) Inventor: Thomas Carnesi, Torrance, CA (US)

(21) Appl. No.: 19/035,070

(22) Filed: Jan. 23, 2025

(51) Int. Cl. B25B 13/46; B25B 23/00

(52) U.S. Cl. CPC B25B 13/462; B25B 23/0035

(57) ABSTRACT

A ratchet wrench tool comprising an adjustable socket having a plurality of jaw members and for securing a fastener and a handle. When the wrench is rotated in the clockwise or counter clockwise directions, the jaw members move inwardly or outwardly to grasp the fastener member. The handle is used to rotate the matchet wrench in a manner whereby the fastener member is secured in a receptacle.

### BACKGROUND OF THE INVENTION

### 1. Field of the Invention

The present invention relates to a socket ratchet wrench, and in particular, a wrench in which the handle is used to adjust jaw members that capture a hexagonal shaped fastener.

### 2. Description of Prior Art

Adjustable socket ratchet wrenches have been widely available in the prior art. For example, U.S. Pat. No. 5,421,225 to Chen describes a wrench having a fixed and movable handle, each having a recess to store various tool bits. The fixed movable handle can be turned to each other from a perpendicular to a parallel relation to smaller sizes for convenient carrying and storage.

Although Chen describes a wrench handle that can be arranged to have a smaller footprint, it is a device designed to provide a single function.

U.S. Patent application Serial No. 16/010621 invented by the inventor of the instant application, filed on Jun. 18, 2018, now abandoned and incorporated herein by reference, describes an adjustable socket ratchet wrench combination interchangeable with universal individual sockets and screwdriver attachments. A slidable handle can be extended to two positions and flexible to three angles from a 180° position. The handle sub-assembly can be folded to the 90° position for storage.

The handle subassembly as described in the '621 application is a relatively complex and expensive part of the combination disclosed. What is desired to provide a ratchet wrench assembly which incorporates the basic concept set forth in the '621 application but utilizes a less expensive handle.

### SUMMARY OF THE INVENTION

A three upper jaw member adjustable socket, manually operated by means of a lower knurled cylindrical adjusting knob, is rotated in either a clockwise or counter-clockwise direction to adjust the three upper jaw members to accept a particular hexagonal fastener size.

The lower adjusting knob being rotated in either a clock-wise or counter-clock-wise direction enables the three jaws to react to the rotational adjustments to larger or smaller jaw movements.

The lower knurled cylindrical thumb knob is secured by a horizontal set screw to retain a cylindrical spacer which, in turn, retains a commonly available ratchet wrench to allow a user to rotate the socket in a clockwise or counter-clockwise direction in order to position the fastener in a receptacle.

### DESCRIPTION OF DRAWINGS

For better understanding of the present invention as well as other objects and further relevant features thereof, reference is made to the following description which is to be read in conjunction with the accompanying drawings wherein:

FIG. 1 is an assembled isometric view of the device shown in FIG. 2; and

FIG. 2 is an exploded perspective view of the three jaw adjustable socket and ratchet wrench device of the present invention.

### DESCRIPTION OF THE INVENTION

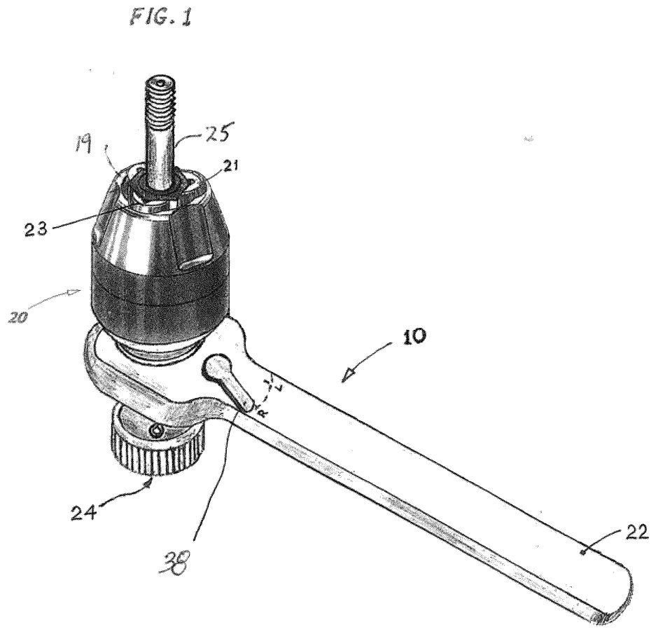

FIG. 1 is an isometric view of the assembled three jaw adjustable socket wrench 10 of the present invention. Three equally spaced jaw members 19, 21, and 23 are shown grasping a standard hexagonal threaded bolt (or nut fastener) 25. As noted in the '062 application (incorporated herein by reference), each jaw member has a 120-degree interior to grasp each side of bolt 25. The adjustable socket 20 is identical to the adjustable socket disclosed in the '062 application. Thus, for the sake of brevity, the details thereof will not be set forth.

In accordance with the teachings of the present invention, the complex (and expensive) handle used to adjust the jaw members used in the wrench described in the aforementioned application is replaced with a commercially available reversible wrench 22 available in most hardware stores.

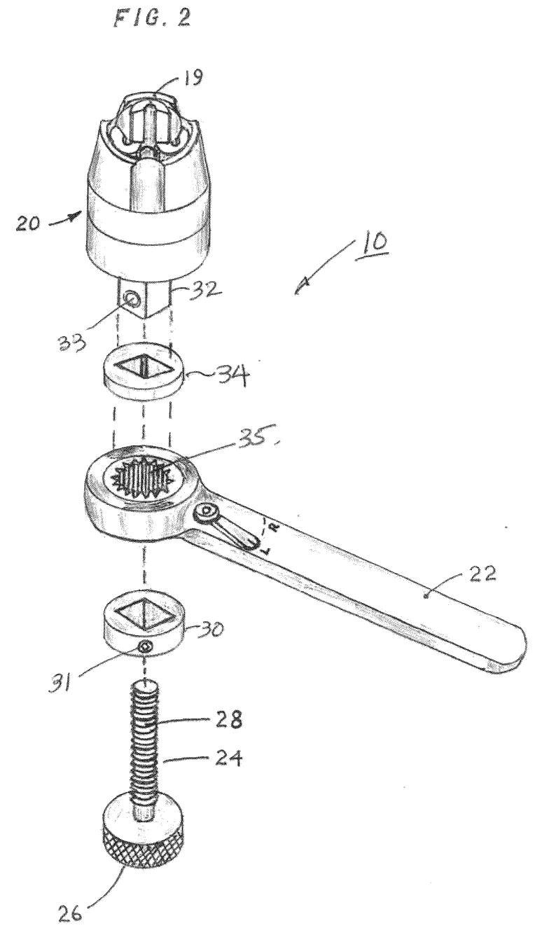

Adjustment screw member 24 (shown in more detail in FIG. 2) comprises a knurled head 26 and an elongated threaded screw 28. Screw member 24 secures wrench 22 to socket 20 in a manner that allows a user to move wrench 22 horizontally in either direction depending upon the size of the fastener to be used.

FIG. 2 is an exploded cross-sectional view of the device shown in FIG. 1.

Threaded screw portion 28 passes through nut 30, and is secured in place by set screw 31. Mounting support 32 (part of socket 20) is inserted into the serrated opening 35 of handle 22 via nut 34 and is secured thereto by screw 33.

In order to insert and secure bolt 25 into an aperture formed in a receiving member (not shown), the device user grasps handle 22 and rotates in either a clockwise or counter-clockwise direction by positioning knob 38 correspondingly.

Jaw members 19,21, and 23 are adjusted by means of socket 20 which, in turn, is controlled by the rotation of knurled threaded adjusting screw 24. Rotating screw 24 in a clockwise direction causes the internal components of socket 20 to elevate the jaw members 19, 21, and 23 in a manner such that they are positioned to grasp the head of a larger sized bolt or fastener to be installed in the receiving member.

Counter-clockwise rotation of screw 24 causes the jaw members to retract to grasp smaller sized bolts or fasteners.

In the position (R) illustrated, handle 22 rotates in the clockwise direction; by moving knob 28 to the position indicated by the reference letter “L” the handle rotates in the counter-clockwise direction.

In this manner, device 10 is able to grasp a bolt or nut of almost any size by the three jaw members noted above and then use handle 22 to insert the bolt or nut into a receiving member.

In summary, the present invention provides an adjustable socket manually operated by means of a lower knurled cylindrical adjusting knob, by rotation in either clockwise or counterclockwise direction to adjust the three upper jaw members accept a particular sized hexagonal fastener (i.e. size ranging from ⅜ inches to 11/16 inches).

As the lower adjusting knob is being rotated in either a clockwise or counterclockwise direction, the three jaws react by moving closer or further from each other while commercially available handle 22 is utilized to install the fastener into the receiving member.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings

What is claimed is:

1. A ratchet wrench tool comprising:
a handle member;
an adjustable socket removably attached to said first end for securing a fastener member, a main ratchet assembly positioned below said adjustable socket; said handle being of a fixed length; and
means for coupling said ratchet wrench to said adjustable socket.

2. The ratchet wrench of claim 1 further including a plurality of jaw members, user rotation of said coupling means causing said jaw members to move to a position towards or away from each other.

3. The ratchet wrench of claim 2 wherein the position of said jaw members is based on the dimensions of said fastener member.

4. The ratchet wrench of claim 3 wherein rotation of said handle causes the socket member to rotate in a direction wherein said fastener member is secured in a receiving receptacle.
